(19) United States
(12) Patent Application Publication
(10) Pub. No.: US 2003/0099038 A1
(43) Pub. Date: May 29, 2003

(54) Thin film filter for optical multiplexer/demultiplexer

(75) Inventors: Hideji Takahashi, Mohka (JP); Takashi Sato, Mohka (JP); Toshio Kobayashi, Fujioka (JP); Shin Noguchi, Mohka (JP)

Correspondence Address: SUGHRUE MION, PLLC, 2100 PENNSYLVANIA AVENUE, N.W., WASHINGTON, DC, 20037, US

(73) Assignee: HITACHI METALS, LTD.

(21) Appl. No.: 10/293,269

(22) Filed: Nov. 14, 2002

(30) Foreign Application Priority Data
Nov. 28, 2001 (JP) 2001-363372

(51) Int. Cl. G02B 5/28

(52) U.S. Cl. 359/589; 216/24

(57) ABSTRACT

A highly reliable thin film filter for an optical multiplexer/demultiplexer is disclosed, in which defects such as chips or cracks hardly occur in an optical thin film. The thin film filter consists of a glass base plate and the optical thin film formed on the glass base plate surface. A side surface of the optical thin film is at an acute angle, preferably at an angle of 6 to 60 degrees, with the glass base plate surface at a crossing point between the optical thin film side surface and the glass base plate surface on a plane perpendicular to the glass base plate surface. After the optical film is formed on the glass base plate surface and the optical thin film side surface is made by dry-etching, an individual thin film filter element is made by cutting the glass base plate with a dicer or the like. Defects such as chips or cracks do not occur on the optical thin film side surface, since the optical thin film is not cut during the cutting of the glass base plate. The optical thin film side surface is substantially free from chips or cracks since it is formed in an oblique surface.

### BACKGROUND OF THE INVENTION

1. Field of the Invention

The present invention relates to a thin film filter for an optical multiplexer/demultiplexer used for DWDM (Dense Wavelength Division Multiplexing) and a method for manufacturing the same.

2. Description of the Related Art

The thin film filter for an optical multiplexer/demultiplexer is designed to allow the light having a specific wavelength to be transmitted, while the light having a range of wavelengths on either side of the pass band bandwidth is reflected. Particularly in the case of the Dense Wavelength Division Multiplexing, a pass band bandwidth of, for example, 1545.00+/−0.20 nm has wavelength 1544.20 nm or 1545.80 nm for next pass band bandwidths in close proximity to each other, so that the transition from the non-transmission region to the transmission region is required to be as steep as possible. The thin film filter has a glass base plate and an optical thin film formed on the surface of the glass base plate. The optical thin film comprises cavities each of which has a mirror layer consisting of a plurality of layers obtained by alternately laminating a film of a high refractive index material having an optical film thickness of a quarter-wave and a film of a low refractive index material having an optical film thickness of a quarter-wave, a hole (a spacer layer) having an optical film thickness of an integral multiple of a half-wave formed on the mirror layer, and another mirror layer provided on the hole symmetrically to the above mirror layer. The optical thin film has achieved the aforementioned optical characteristics by repeatedly laminating four to five layers of the cavities. Generally, silicon dioxide (SiO₂) is used as the low refractive index material, and tantalum pentoxide (Ta₂O₅) or the like is used as the high refractive index material. The optical film thickness means a physically measured thickness multiplied by a refractive index of the material.

In the thin film filter for an optical multiplexer/demultiplexer for Dense Wavelength Division Multiplexing for 200 GHz having a pass band bandwidth of 0.8 (nm), mirror layers and spacer layers have been composed of about 90 optical thin film multi-layers, but for 100 GHz having a further narrower pass band bandwidth they are composed of optical thin film multi-layers having a hundred and several tens of layers, in total. A total thickness of the laminated films is 30 μm or more, resulting in increased residual stress in the films. The glass base plate has a thermal expansion coefficient of about 110×10⁻⁷/° C. and the optical thin film has a thermal expansion coefficient of about 30×10⁻⁷/° C., which shows a big difference of thermal expansion coefficients between the used materials. The glass base plate is heated to a temperature of several hundred degrees Centigrade for forming the optical thin film thereon. Temperature dependence of optical transmittance characteristics of the optical thin film is made smaller by the difference of the thermal expansion coefficients between the glass base plate and the optical thin film, which causes the optical thin film to be under great stress. In order to cut the glass base plate with the optical thin film formed thereon to make a filter element, the glass base plate and the multi-layered optical elements provided on the surface of the glass base plate need to be simultaneously cut. When the glass base plate and the optical thin film are simultaneously cut, chips as well as cracks occur on edges and corners at the periphery of the optical thin film. Fine cracks occur also at an interfacial surface of the glass base plate and the optical thin film. These cracks and chips impair the optical characteristics of the thin film filter for an optical multiplexer/demultiplexer. The occurrence of cracks in the optical thin film changes the optical characteristics of the thin film by relaxing stress of the optical thin film. For example, a central wavelength of the pass band bandwidth is varied or the pass band bandwidth is broadened. In addition, since a use environment of the thin film filter for an optical multiplexer/demultiplexer is in a range from below the ice point to an elevated temperature, it undergoes a temperature cycle to develop the cracks, resulting in delamination between the base plate and the optical thin film at the worst.

FIG. 7 illustrates a perspective view of a conventional thin film filter 200 for an optical multiplexer/demultiplexer. A glass base plate 220 and an optical thin film 210 are simultaneously cut with a grindstone, so that it has chips 204 and 204′ and cracks 205 and 205′. The range of the defects in the optical thin film due to the chips 204 and 204′ is from several μm to several hundred μm, and the range due also to the cracks 205 and 205′ is from several tens μm to several hundred μm or more. In addition, optical characteristics have changed in the range of the optical thin film where stress relaxation has occurred due to the cracks. For the optical thin film having chips and cracks, only the portion excluding where there are chips and cracks and its surroundings can be used for a thin film filter for an optical multiplexer/demultiplexer. Thus, a filter having a size w must be used, which has a sufficient allowance as compared with a portion having a diameter of d to be used for a filter. This has caused a problem that the less number of thin film filters can be produced from a substrate.

### SUMMARY OF THE INVENTION

It is an object of the present invention to provide a highly reliable thin film filter for an optical multiplexer/demultiplexer, in which defects such as chips or cracks hardly occur in the optical thin film.

It is a further object of the present invention to provide a thin film filter for an optical multiplexer/demultiplexer, in which the number of thin film filters for an optical multiplexer/demultiplexer produced from a substrate can be increased.

The thin film filter for an optical multiplexer/demultiplexer according to the present invention has a glass base plate and an optical thin film formed on the surface of the glass base plate. A side surface of the optical thin film is at an acute angle with the glass base plate surface at a crossing point between the optical thin film side surface and the glass base plate surface on a plane perpendicular to the glass base plate surface. The optical thin film has a plurality of laminated cavities, each of the cavities has a spacer layer and two sets of mirror layers each of which is laminated on each side of the spacer layer symmetrically to one another, and each sets of the mirror layers having a plurality of low refractive index films and a plurality of high refractive index films laminated alternately with each other.

The thin film filter for an optical multiplexer/demultiplexer according to the present invention preferably has a portion of the optical thin film side surface of from the glass base plate surface to one tenth thickness of the optical thin film which is at an angle of 6 to 60 degrees with the glass base plate surface at a crossing point between the optical thin film side surface and the glass base plate surface on a plane perpendicular to the glass base plate surface.

The thin film filter for an optical multiplexer/demultiplexer according to the present invention preferably has an edge of the optical thin film side surface on the plane perpendicular to the glass base plate surface which is at a distance from an edge of the glass base plate surface on the plane perpendicular to the glass base plate surface.

Furthermore, the thin film filter for an optical multiplexer/demultiplexer according to the present invention may have the optical thin film of a polygonal truncated pyramid. The polygonal truncated pyramid includes from a truncated pyramid to n-polygonal truncated pyramid (n: integer), and also includes a truncated cone. Such a shape as an n-polygonal truncated pyramid with its corners formed to an arc, that is, rounded-corners is also included. The shape of a polygonal truncated pyramid is the one which has a polygonal upper surface, a lower surface having the same number of corners as the upper surface and oblique surfaces, the lower surface having a larger area than the upper surface. In the present invention, an optical thin film surface in contact with a glass base plate is referred to as a lower surface and the opposite surface is referred to as an upper surface. The dimension of diagonal lines for the upper surface needs to be larger than an incident light diameter.

The shape of a base plate of a thin film filter for an optical multiplexer/demultiplexer according to the present invention is not limited to the one which has a similar figure as the shape of the lower surface. A glass base plate in the shape of a rectangle may have an optical thin film of either a truncated cone, a truncated pyramid or an n-polygonal truncated pyramid. A base plate is made by cutting a large glass plate or a substrate with a grindstone or the like, so that the shape of the base plate is preferably a triangle or a rectangle. It is important that a base plate does not absorb light in proximity to wavelengths of a pass band region, and a material such as a soda glass may be used for the base plate.

The side surface of a polygonal truncated pyramid is composed of one or more planes or curved surfaces, and may include a combination of planes and curved surfaces. The curved surface may include the shape of a concave surface or a convex surface. A portion of the optical thin film side surface which is close to a crossing point between the base plate and the optical thin film is advantageously a plane or a concave surface to prevent delamination between the base plate and the optical thin film.

The side surface of the optical thin film of the thin film filter for an optical multiplexer/demultiplexer according to the present invention is preferably made by dry-etching.

A method for producing the thin film filter for an optical multiplexer/demultiplexer according to the present invention comprises the steps of forming an optical thin film all over the base plate, providing a mask for dry-etching on the optical thin film, dry-etching an unmasked portion for the dry-etching to form the optical thin film in the shape of a polygonal truncated pyramid and expose a cutting allowance of the base plate for cutting with a grindstone or the like, removing the mask for the dry-etching, and cutting the cutting allowance where the base plate is exposed with the grindstone or the like to form an element.

A glass base plate is placed in a vacuum deposition apparatus, and on one of its surfaces a mirror layer is provided by alternately depositing and laminating a layer of silicon dioxide having a high refractive index and a layer of tantalum pentoxide or the like having a low refractive index, each layer having an optical film thickness of a quarter-wave. A cavity is formed by providing a hole (a spacer layer) of silicon dioxide or tantalum pentoxide or the like having an optical film thickness of an integral multiple of a half-wave on the mirror layer, and by forming again the other mirror layer on top of the hole, such that the two mirror layers are located symmetrically with the spacer layer. Four to five layers of the cavities are repeatedly laminated to form an optical thin film on the glass base plate.

A mask for dry-etching is then provided. The mask is preferably manufactured by a photolithography technology. A photoresist is applied all over the surface of the optical thin film, exposed and developed to form a photoresist mask. Although a metal can also be formed similarly into a film to make a mask, the photoresist is preferably used for ease in removing the mask after dry-etching.

An unmasked portion of the photoresist is dry-etched to process the optical thin film into a predetermined shape. When reactive ion etching is used, only the optical thin film can be etched, so that the base plate is not etched. When ion milling is used, not only the optical thin film but also the base plate is etched, so that the time for operating the ion milling needs to be controlled. A small shaving of the base plate will present no problem. During the ion milling, the base plate can be inclined a predetermined angle with respect to the direction of atomic incidence, and in addition the base plate can be rotated to control the angle of the oblique surface of the polygonal truncated pyramid of the optical thin film. It is important that the portion for a cutting allowance, where the base plate is cut to make a base for the optical thin film, is in a state that all of the optical thin film is removed, in order to prevent the occurrence of chips or cracks when cut by a grindstone or the like.

After the optical thin film on the base plate is processed to the shape of a polygonal truncated pyramid, the mask is removed to obtain a large number of optical thin films having the shape of a polygonal truncated pyramid placed on the base plate. By cutting with a grindstone along the cutting allowance where the optical thin film has been removed, a large number of thin film filters for an optical multiplexer/demultiplexer having an optical thin film in the shape of a polygonal truncated pyramid on the cut glass base plate can be obtained. Conventionally, since an optical thin film and a base plate need to be cut at the same time, cutting conditions suitable for each material could not be applied, but grindstones or conditions which comprehensively provide less chips or cracks have to be applied. According to the present invention, since it is only the base plate that is cut by a grindstone, abrasives, particle sizes and cutting speed of the grindstone which will be optimum for the base plate can be selected. This results in a width of the chips and cracks of less than several μm when the base plate is cut by the grindstone, and the chips or cracks have no optical influence on the optical thin film.

### BRIEF DESCRIPTION OF THE DRAWINGS

FIG. 1 is a perspective view of one embodiment of a thin film filter for an optical multiplexer/demultiplexer according to the present invention;

FIG. 2 is a plan view for illustrating an optical multiplexer/demultiplexer using a thin film filter for an optical multiplexer/demultiplexer according to the present invention;

FIG. 3 is an enlarged sectional view illustrating part of the section along the line III-III of FIG. 1;

FIGS. 4A to 4D are perspective views of other embodiments of a thin film filter for an optical multiplexer/demultiplexer according to the present invention;

FIGS. 5A to 5G illustrate production steps of a thin film filter for an optical multiplexer/demultiplexer according to the present invention;

FIG. 6 is a graphical representation illustrating a relation between a side surface angle θ and the occurrence of chips and cracks in a thin film filter for an optical multiplexer/demultiplexer according to the present invention; and

FIG. 7 illustrates a conventional thin film filter for an optical multiplexer/demultiplexer in a perspective view.

### DETAILED DESCRIPTION OF THE PREFERRED EMBODIMENTS

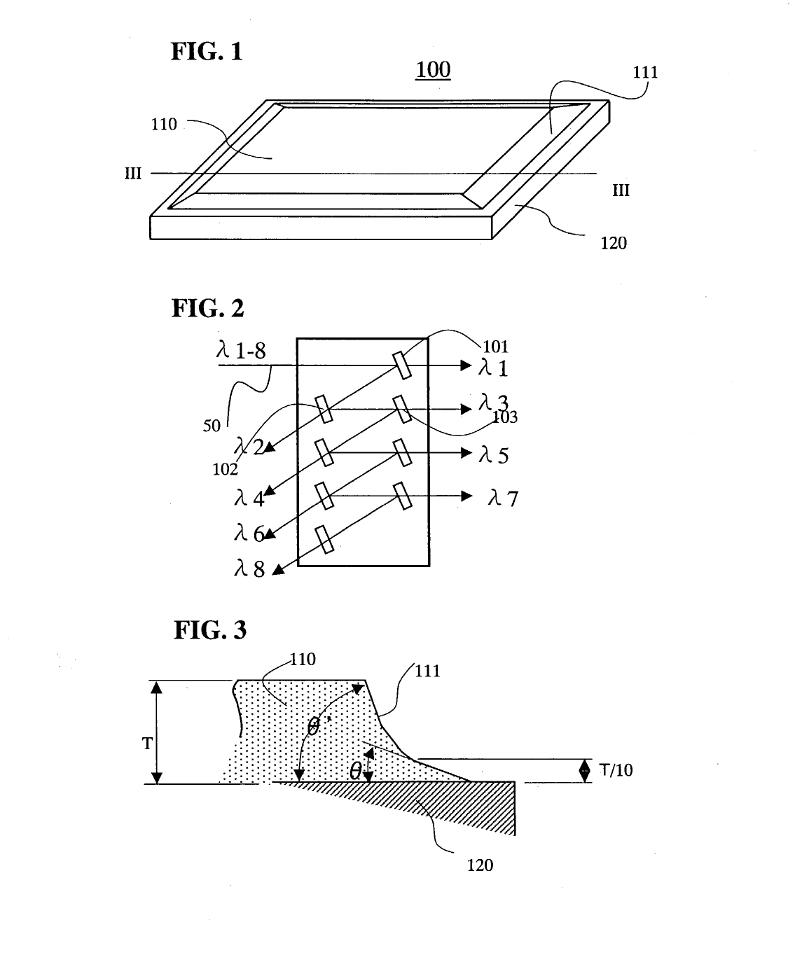

The embodiments of the present invention will now be described in detail with reference to the drawings. A thin film filter 100 for an optical multiplexer/demultiplexer according to the present invention, as shown in FIG. 1 in a perspective view, has an optical thin film 110 formed on a glass base plate 120. The optical thin film 110 allows only the light having specific wavelengths, to be more precise, the light within a specific wavelength band to be transmitted, and the light having other wavelengths is reflected.

The optical multiplexer/demultiplexer shown in FIG. 2 uses eight pieces of the thin film filter 100 of FIG. 1. The light signal having wavelengths of λ1 to λ8 sent through an optical fiber 50 is demultiplexed at the optical multiplexer/demultiplexer. At a first thin film filter 101 of the optical multiplexer/demultiplexer, only the light signal having a wavelength of λ1 is transmitted to be demultiplexed and other light signals are reflected by the first thin film filter 101 to move to a second thin film filter 102. At the second thin film filter 102, only the light signal having a wavelength of λ2 is transmitted to be demultiplexed and other light signals are reflected by the second thin film filter 102 to be sent to a third thin film filter 103. After that, the light signal is demultiplexed for each wavelength in sequence by each thin film filter, and finally eight kinds of light signals are demultiplexed by eight thin film filters.

The optical thin film has cavities composed of a mirror layer consisting of a plurality of layers obtained by alternately laminating a film of a high refractive index material (for example, a tantalum pentoxide film) having an optical film thickness of a quarter-wave and a film of a low refractive index material (for example, a silicon dioxide film) having an optical film thickness of a quarter-wave, a hole (a spacer layer) having an optical film thickness of an integral multiple of a half-wave formed on the mirror layer, and another mirror layer provided symmetrically to the above mirror layer on the hole. The optical thin film is obtained by repeatedly laminating four to five layers of the cavities. Detailed structure of the optical thin film is described in Cushing's U.S. Pat. No. 6,018,421 (issued Jan. 25, 2000) and is not an object of the present invention, so it will not be described in further detail. The optical thin film is a multi-layer film as explained above, but is described as an integrated film in the following description and drawing, as long as there is no need.

Referring to FIGS. 1 and 3, a thin film filter for an optical multiplexer/demultiplexer 100 according to a first embodiment of the present invention is comprised of a glass base plate 120 and an optical thin film 110 having the shape of a rectangular truncated pyramid formed on the glass base plate, and its side surface 111 on the periphery of the optical thin film is an oblique surface. The side surface 111 is at an acute angle θ with the glass base plate surface at a crossing point between the side surface and the glass base plate surface on a plane perpendicular to the glass base plate surface (FIG. 3 illustrates a section on the plane perpendicular to the glass base plate surface). Preferably, a portion of the optical thin film side surface 111 of from the glass base plate surface to one tenth thickness T of the optical thin film is at an angle θ of 6 to 60 degrees with the glass base plate surface. In FIG. 3, the oblique surface angle θ of the optical thin film 110 is the angle which a portion of the optical thin film side surface of from the glass base plate surface to one tenth thickness T of the optical thin film makes with the glass base plate surface at a crossing point between the side surface and the glass base plate surface on a plane perpendicular to the glass base plate surface. In addition, at the top of the optical thin film side surface, the oblique surface makes an angle θ′ with the glass base plate surface. The angle θ′ is from 45 to 90 degrees.

The side surface 111 of the optical thin film has a structure in which a layer of a low refractive index material and a layer of a high refractive index material, each material being different, are alternately laminated, so that when etched by dry-etching the side surface is etched in tiers microscopically due to the difference of an etching speed based on material. The side surface angle is the angle between the glass base plate surface and a side surface, which is defined by connecting the top of each tier. Since the optical thin film is more stressed at a portion of smaller thickness, the smaller the angle at a portion of the optical thin film lower than one tenth of the total thickness tends to be less susceptible to chipping or the like.

When the side surface angle θ is 60 degrees or larger, the optical thin film becomes susceptible to delamination from the glass base plate. In the experiment shown below, when the oblique surface angle θ is increased larger than 60 degrees, the rate of the occurrence of chips and cracks has drastically increased. This is the reason why the upper limit of the oblique surface angle θ has been defined to be 60 degrees. When the oblique surface angle is 6 degrees or less, the lower surface of the optical thin film becomes larger, which results in decrease of the number of elements which can be obtained from the base plate.

An edge of the optical thin film side surface on the glass base plate, that is, a point or a line where a side surface of the optical thin film and the glass base plate surface cross is preferably at a distance from an edge of the glass base plate. Since the glass base plate, as described below, is cut with a dicer or the like to be separated, the optical thin film is preferably at a distance from the cutting portion of the glass base plate so that the optical thin film is not cut during the cutting of the glass base plate. The distance between the edge of the optical thin film and the edge of the glass base plate is preferably as small as possible because it is a wasted space as an optical thin film.

The optical thin film side surface having the shape of a polygonal truncated pyramid of the thin film filter for an optical multiplexer/demultiplexer according to the present invention is preferably a surface made by dry-etching. The dry-etching performs processing by applying etching gas or atoms to a surface to be processed. For example, reactive ion etching, ion milling or the like may be used. In the reactive ion etching, the materials composing the optical thin film chemically react with a specific gas to form an easily evaporated compound, which is vaporized to etch the film. Since such processing is the processing by atoms or molecules, chips or cracks due to physical impact rupture do not occur different from grindstone cutting. In the case of the ion milling, accelerated argon atoms or the like are allowed to be collided against the optical thin film. The impact etches the optical thin film by rupturing and scattering it into molecules.

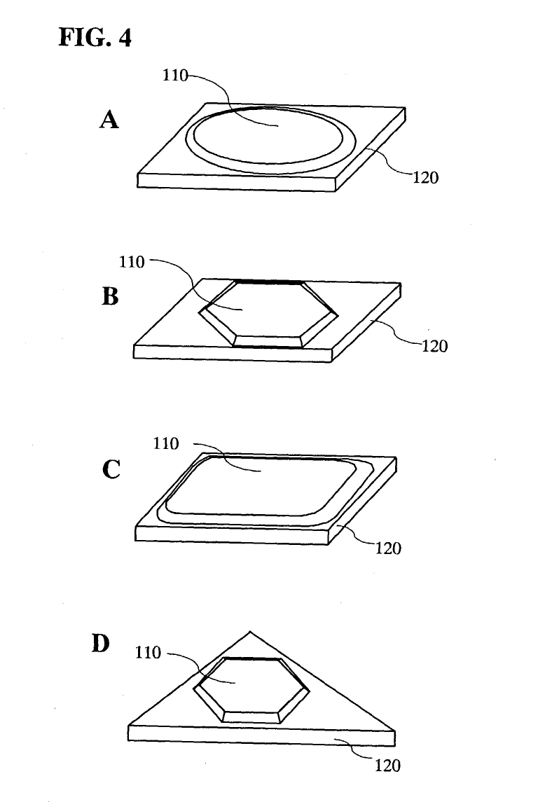

FIG. 4 is a perspective view of other embodiments of a thin film filter for an optical multiplexer/demultiplexer according to the present invention. FIG. 4A illustrates an optical thin film 110 having a truncated cone and a rectangular base plate 120; FIG. 4B illustrates an optical thin film 110 having a hexagonal truncated pyramid and a rectangular base plate 120; FIG. 4C illustrates an optical thin film 110 having a rectangular truncated pyramid with its corners formed to an arc and a rectangular base plate 120; and FIG. 4D illustrates an optical thin film 110 having a hexagonal truncated pyramid and a triangle base plate 120, for composing a thin film filter for an optical multiplexer/demultiplexer. Since the base plate is formed by cutting a glass plate with a grindstone, it may be either a rectangle including a parallelogram and a triangle, in combination with an optical thin film 110 of a polygonal truncated pyramid.

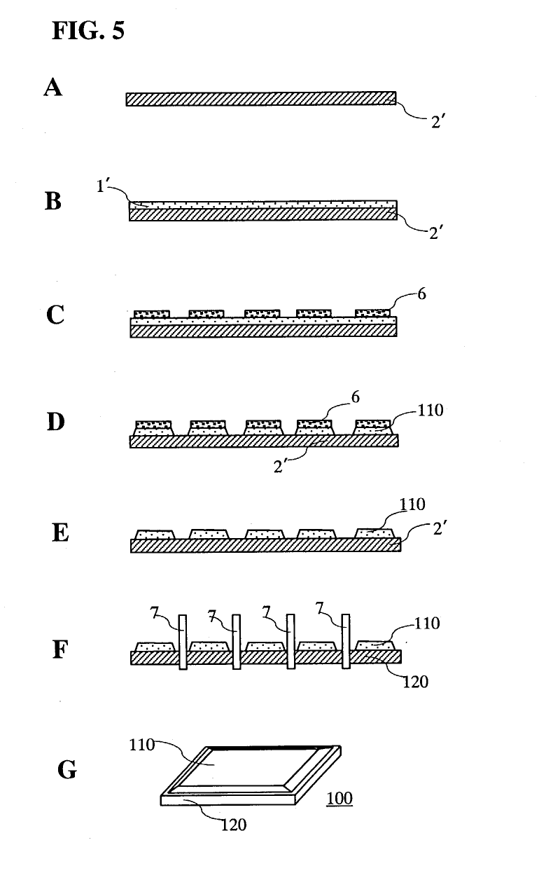

A production method used in the present embodiment will now be described with regard to FIG. 5. A glass plate 2′ is first provided (FIG. 5A). The glass plate 2′ is set in a vacuum evaporation apparatus and heated to a temperature of about 300° C., and then a silicon dioxide film and a tantalum pentoxide film are formed thereon at a degree of vacuum of 1.2×10⁻² Pa. A low refractive index film having an optical film thickness of λ/4 (λ: wavelength) (a silicon dioxide film having a physical film thickness of 265 nm) and a high refractive index film having an optical film thickness of λ/4 (a tantalum pentoxide film having a physical film thickness of 180 nm) were alternately laminated repeatedly to form a mirror layer consisting of 15 layers of films in total. A film of silicon dioxide having a physical thickness of 1,590 nm was formed on the mirror layer such that it has an optical film thickness three times λ/2. The film is called a hole (spacer layer). Another mirror layer was provided again on the hole such that the mirror layer is symmetrical to the former mirror layer with respect to the hole. A combination of a mirror layer, a hole and another mirror layer further formed on the hole is called a cavity. An optical thin film 1′ having a total number of laminated layers of 124 layers was produced by laminating four layers of the cavities repeatedly (FIG. 5B). The optical thin film has a thickness of about 33 μm. The glass base plate on which the optical thin film is formed has a thickness of about 10 mm, the back side of which is shaved down to a thickness of about 1 mm by CMP (Chemical Mechanical Polishing). The CMP process is not illustrated in FIG. 5. A photoresist was applied onto the surface of the optical thin film 1′ to a thickness of 12 μm, cured at 90° C., and then exposed and developed by use of a contact aligner to form a photoresist mask 6 for dry-etching (FIG. 5C). The optical thin film at an unmasked portion was selectively etched to be removed by a reactive ion etching (FIG. 5D). The reactive ion etching apparatus was of an inductively coupled plasma system. The reactive ion etching was carried out for about 240 minutes, using a mixed gas consisting of tetrafluoromethane (CF₄), trifluoromethane (CHF₃) and oxygen (O₂) as a reactive gas. The etching can be either isotropic or anisotropic etching by changing the pressure of the reactive gas. The anisotropic etching was carried out with a gas pressure of 5.3 Pa from the beginning to the middle of the reactive ion etching operation, and around the end of the reactive ion etching operation the isotropic etching was carried out with the gas pressure raised to 13 to 20 Pa until the surface of the base plate 2′ is exposed. By changing the gas pressure in this manner, the oblique surface angles shown in FIG. 3 were controlled such that θ′ of 85 degrees and θ of 35 degrees are obtained.

After the optical thin film 1′ was processed into a shape of a rectangular truncated pyramid, the photoresist for a dry-etching mask was removed with acetone (FIG. 5E). The glass plate 2′ on which the optical thin films 110 having a shape of a rectangular truncated pyramid were positioned in a checkered pattern was cut and separated with a cutting grindstone 7 (FIG. 5F), and a thin film filter for an optical multiplexer/demultiplexer 100 was obtained which has an optical thin film 110 having a shape of a rectangular truncated pyramid on a base plate 120 (FIG. 5G). The cutting was carried out with a diamond grindstone and at a speed of 250 mm/min.

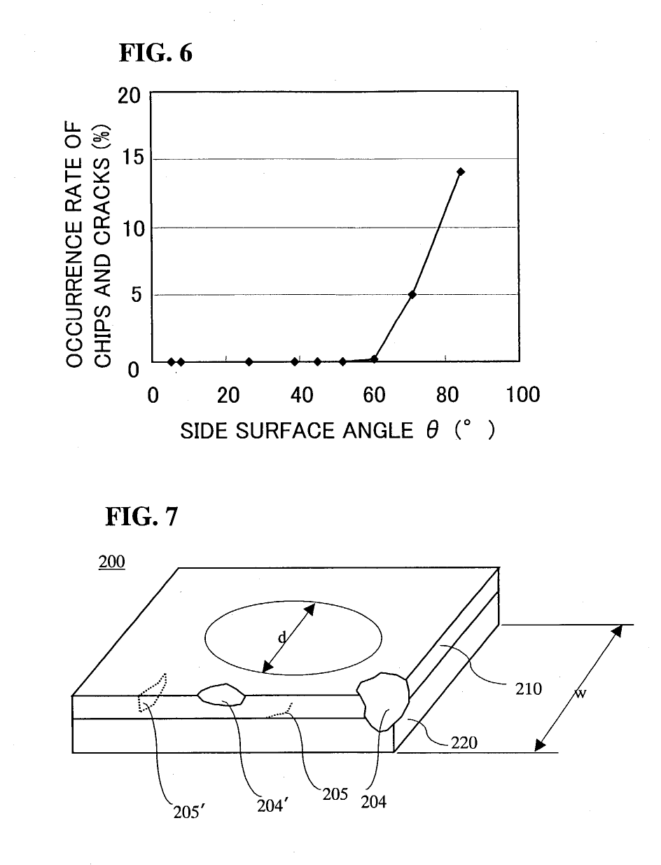

A relation between an oblique surface angle θ and the occurrence of chips and cracks in a thin film filter for an optical multiplexer/demultiplexer according to the present invention is illustrated in a graphical representation of FIG. 6. The base plate and the optical thin film were both in a shape of a rectangular truncated pyramid, and the oblique surface angle θ was changed from 5.2 degrees to 84.2 degrees. The oblique surface angle θ′ was made from 85 degrees to 88 degrees. The distance between the optical thin film edge and the base plate edge was made from 3 to 5 μm. The number of thin film filters for an optical multiplexer/demultiplexer whose optical thin film has one or more chips or cracks having a size of 5 μm or larger was divided by the total number of the thin film filters for an optical multiplexer/demultiplexer inspected, and the result is shown as a percentage to obtain a rate of the occurrence of chips and cracks. The total number of the thin film filters for an optical multiplexer/demultiplexer inspected is 2,965 pieces. The optical thin film having θ of 60 degrees or less was found to have no chips and cracks. The rate of the occurrence of chips and cracks remarkably increased to 5.1% at θ of 70 degrees and 14.5% at θ of 85 degrees. When θ reaches 85 degrees, the gradient of the oblique surface becomes uniform, and θ and θ′ are virtually indistinguishable. Even when the oblique surface becomes uniform, the rate of the occurrence of chips and cracks can be reduced by bringing θ within the range stipulated in the present invention.

Five hundred pieces in total of the thin film filters for an optical multiplexer/demultiplexer having θ of from 5 degrees to 85 degrees which include no chips and cracks underwent a thermal cycle test, in which the thin film filters were maintained at −30° C. for 30 minutes, heated to 80° C. at a speed of 5° C./minute, maintained at 80° C. for 30 minutes, and then cooled to −30° C. at a similar temperature gradient. The thermal cycle was carried out 30 times before inspecting the chips and cracks. No new chips and cracks have occurred during the thermal cycle test for the thin film filters for an optical multiplexer/demultiplexer having an oblique angle θ of 70 degrees or less. For the thin film filters for an optical multiplexer/demultiplexer having an oblique angle θ of 85 degrees, the cracks which look like delamination between a base and an optical thin film have occurred in three pieces among 45 pieces. From this result, the thin film filter for an optical multiplexer/demultiplexer with the stipulated θ according to the present invention has shown high reliability even under a severe temperature environment.

As described above, it was possible to eliminate chips and cracks, which conventionally entered several hundred μm from the edge of the optical thin film. It was possible to reduce the outer dimension w of the base plate 2 of the thin film filter for an optical multiplexer/demultiplexer according to the present invention, approximately to a size which is obtained by adding a length of the optical thin film oblique surface and a chip width of the base of several μm to an optical diameter d. Thus, it was possible to increase the number of the thin film filters for an optical multiplexer/demultiplexer which can be obtained from one piece of glass plate, by about 5%.

As described above, it was possible to prevent the occurrence of chips and cracks in an optical thin film by cutting only a base plate with a grindstone after the optical thin film is processed to a shape of a polygonal truncated pyramid by dry-etching, and it was possible to obtain a highly reliable thin film filter for an optical multiplexer/demultiplexer without a new occurrence of chips and cracks due to temperature change. In addition, it was possible to increase the number of thin film filters for an optical multiplexer/demultiplexer which can be produced from a base plate, and it was possible to provide a less expensive thin film filter for an optical multiplexer/demultiplexer.

What is claimed is:

1. A thin film filter for an optical multiplexer/demultiplexer comprising a glass base plate and an optical thin film formed on a surface of the glass base plate,
the optical thin film having a plurality of laminated cavities,
each of the cavities having a spacer layer and two sets of mirror layers each of which is laminated on each side of the spacer layer symmetrically to one another,
each sets of the mirror layers having a plurality of low refractive index films and a plurality of high refractive index films laminated alternately with each other,
wherein a side surface of the optical thin film is at an acute angle with the glass base plate surface at a crossing point between the optical thin film side surface and the glass base plate surface on a plane perpendicular to the glass base plate surface.

2. A thin film filter as set forth in claim 1, wherein a portion of the optical thin film side surface of from the glass base plate surface to one tenth thickness of the optical thin film is at an angle of 6 to 60 degrees with the glass base plate surface at a crossing point between the optical thin film side surface and the glass base plate surface on the plane perpendicular to the glass base plate surface.

3. A thin film filter as set forth in claim 1, wherein an edge of the optical thin film side surface on the plane perpendicular to the glass base plate surface is at a distance from an edge of the glass base plate surface on the plane perpendicular to the glass base plate surface.

4. A thin film filter as set forth in claim 2, wherein an edge of the optical thin film side surface on the plane perpendicular to the glass base plate surface is at a distance from an edge of the glass base plate surface on the plane perpendicular to the glass base plate surface.

5. A thin film filter as set forth in claim 1, wherein the optical thin film is a polygonal truncated pyramid.

6. A thin film filter as set forth in claim 2, wherein the optical thin film is a polygonal truncated pyramid.

7. A thin film filter as set forth in claim 3, wherein the optical thin film is a polygonal truncated pyramid.

8. A thin film filter as set forth in claim 1, wherein the optical thin film side surface is made by dry-etching.

9. A thin film filter as set forth in claim 2, wherein the optical thin film side surface is made by dry-etching.

10. A thin film filter as set forth in claim 3, wherein the optical thin film side surface is made by dry-etching.

11. A thin film filter as set forth in claim 4, wherein the optical thin film side surface is made by dry-etching.

12. A thin film filter as set forth in claim 5, wherein the optical thin film side surface is made by dry-etching.

13. A method for producing a thin film filter for an optical multiplexer/demultiplexer comprising the steps of
forming an optical thin film all over a base plate, providing a mask for dry-etching on the optical thin film,
dry-etching an unmasked portion for the dry-etching to form the optical thin film in the shape of a polygonal truncated pyramid and expose a cutting allowance of the base plate for cutting with a grindstone or the like,
removing the mask for the dry-etching, and
cutting the cutting allowance where the base plate is exposed with the grindstone or the like to form an element.
